(19) United States
(12) Patent Application Publication
(10) Pub. No.: US 2010/0126112 A1
(43) Pub. Date: May 27, 2010

(54) Method of anchoring fastening element

(76) Inventors: Andreas Schell, Issing (DE); Klaus-Peter Bohn, Gams (CH); Till Cramer, Jenins (CH)

Correspondence Address: ABELMAN, FRAYNE & SCHWAB, 666 THIRD AVENUE, 10TH FLOOR, NEW YORK, NY, 10017, US

(21) Appl. No.: 12/592,524

(22) Filed: Nov. 24, 2009

(30) Foreign Application Priority Data
Nov. 27, 2008 (DE) 10 2008 044 128.7

(51) Int. Cl. E04B 1/38; E04G 21/00; B23B 35/00

(52) U.S. Cl. 52/745.21; 408/1 R

(57) ABSTRACT

A method of anchoring a fastening element includes drilling a borehole (7) in a constructional component (6) with a percussively-rotationally driven hollow drill (12), while aspirating produced drillings and drilling dust with a vacuum source (26) through a gap between an outer side of the hollow drill (12) and a wall of the borehole (7) during drilling of the borehole (7), immediately after formation of the suction-cleaned borehole (7), filling the borehole (7) with a self-hardenable mortar (41), and inserting the fastening element (46) into the self-hardenable mortar (41).

### BACKGROUND OF THE INVENTION

1. Field of the Invention

The invention relates to a method of anchoring a fastening element and a method of forming a cleaned borehole for anchoring a fastening element.

2. Description of the Prior Art

At a chemical anchoring, fastening elements such as, e.g., threaded rods, reinforcing irons, or dowels are anchored in a borehole preliminary formed in a constructional component, e.g., wall or ceiling, e.g., of a mineral material such as, e.g., concrete or brickwall. In order to be able to achieve high anchoring values of a fastening element in the constructional component or underground, preferably, a substantial cleaning of the borehole is important because drillings or drilling dust, which still remain in the borehole, disadvantageously influence adhesion of the hardenable mass to the borehole wall.

For cleaning a borehole, mechanical devices have already been proposed with which the borehole, after being drilled, is brushed or blown off. The drawback of the known solution consists in that the degree of cleaning depends on the fastidiousness of the user of the device.

German Publication DE 29 12 396 A1 discloses a borehole cleaning process or method using a hollow drill and according to which during drilling of the borehole, air is blown into the borehole through the hollow drill. The produced drillings and drilling dust is blown out of the borehole. With this method, drillings and dust contaminate the borehole environment.

German Publication DE 198 10 193 A1 discloses a borehole-cleaning process or method with a hollow drill and according to which for improved cleaning during the drilling of the borehole, the produced drillings and drilling dust are aspirated through the hollow drill with a vacuum source such as a vacuum cleaner.

The object of the invention is to provide a reliable method of anchoring a fastening element.

Another object of the invention, is a method of forming a cleaned borehole in a constructional component for chemical anchoring a fastening element in the constructional component.

### SUMMARY OF THE INVENTION

These and other objects of the present invention, which will become apparent hereinafter, are achieved by providing a method including the steps of drilling a borehole in a constructional component with a percussively-rotationally driven hollow drill, aspirating produced drillings and drilling dust with a vacuum source between an outer side of the hollow drill and a borehole wall during drilling of the borehole, immediately after formation of the suction-cleaned borehole, filling the borehole with a self-hardenable mortar, and inserting the fastening element into the self-hardenable mortar.

The desired pull-out loads in the range of over 1,000 Newton are transmitted by the self-hardenable mortar only to the constructional component when the drillings are removed by cleaning. In addition, it has been found that the smooth borehole walls, which we formed by sawing or grinding, can be cleaned very well by suction but, however, do not enable any satisfactory adhesion of the mortar to the wall. A partially chiseling tool, which the percussively driven hollow drill forms, provides a sufficient roughness and insures formation of fissures in the borehole wall which provide for an adequate adhesion of the mortar to the borehole wall.

According to one of the embodiments of the inventive method, the borehole is filled with a two-component mass. The self-hardenable mortar can be based on epoxyresin and/or polymethacrylat.

The self-hardenable mortar fills the borehole without any further cleaning of the borehole. The method according to the present invention insures that a fastening element, which is anchored in the self-hardenable mortar, can withstand pull-out loads of at least 1,000 Newton.

According to the invention, during drilling of the borehole with a hollow drill, the drillings and the drilling dust are aspirated by the vacuum source through the gap between the outer side of the hollow drill and the borehole wall.

The foregoing measures provide for drillings and drilling dust constantly being aspirated starting from the drilling head or from the cutters of the hollow drill, outside of the drilling head. Simultaneously, passive air flows through the hollow drill into the borehole, providing for an advantageous air flow pattern in the borehole for removal of the drillings and drilling dust out of the borehole. Thereby, the produced drillings and, in particular, the produced drilling dust are prevented, from the start, from being pressed onto the borehole wall during the drilling process which would have made it very difficult to remove it from the borehole. The inventive method is particular advantageous for anchoring fastening elements in underground and constructional components formed of porous material with respect to the achievable degree of cleaning.

The inventive method enables in a simple manner to integrate the operational steps of drilling and cleaning the borehole, which eliminates a separate and expensive cleaning procedure, and a noticeable increase of the drilling speed.

This permits to achieve a noticeably improved productivity simultaneously with increase of safety and reliability of the chemical anchoring. The reduction of operational expenses for forming a cleaned borehole in comparison with a subsequent cleaning of a borehole by brushing and/or blowing off amounts up to 50% or even more.

Because the inventive method insures uniform, reproducible cleaning with a high degree of cleaning, high specific loads can be applied to a chemically anchored fastening element. The inventive method permits to achieve a smaller decrease of reference load values, so that at the same dimensional characteristics of the chemical anchoring, additional applications become possible.

Advantageously, there is provided a suction hood for covering the borehole and having a through-opening for the hollow drill and a connection union for the vacuum source. Thereby, an underpressure is produced around the hollow drill in a region outside of the borehole. This insures an almost complete removal or aspiration of drillings and drilling dust produced by drilling through a gap between the outer side of the hollow drill and the borehole wall. This measure further improves cleaning of the borehole and specific loads for chemically anchored fastening elements can be increased further. In addition, contamination of the environment is prevented to a most possible degree.

Advantageously, during drilling of a borehole, additional air is blown into the borehole through the hollow drill. Thereby, removal or aspiration of produced, during drilling, drillings and drilling dust through a gap between the outer side of the hollow drill and the borehole wall is further improved.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a schematic view illustrating views of a hollow drill according to the inventive method; and

FIG. 2 a cross-sectional view showing an anchored fastening element.

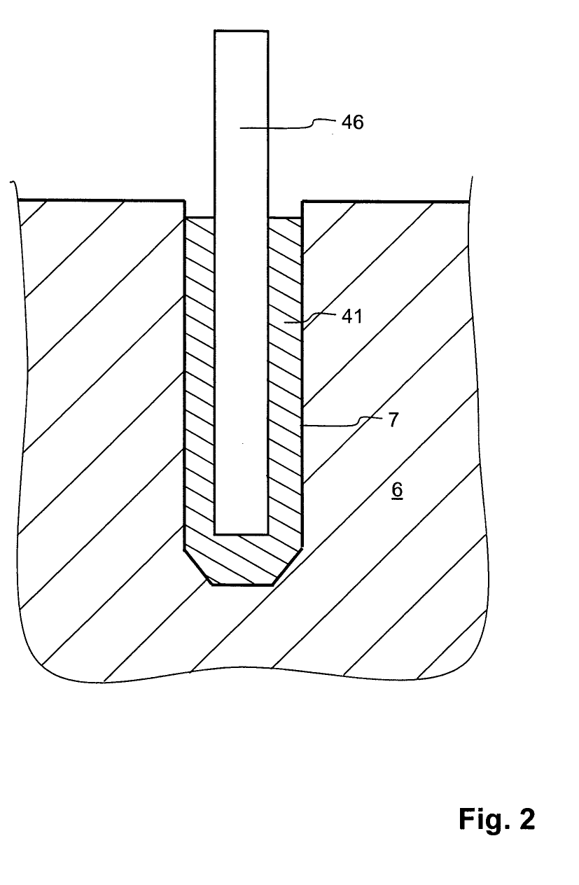

### DETAILED DESCRIPTION OF THE PREFERRED EMBODIMENT

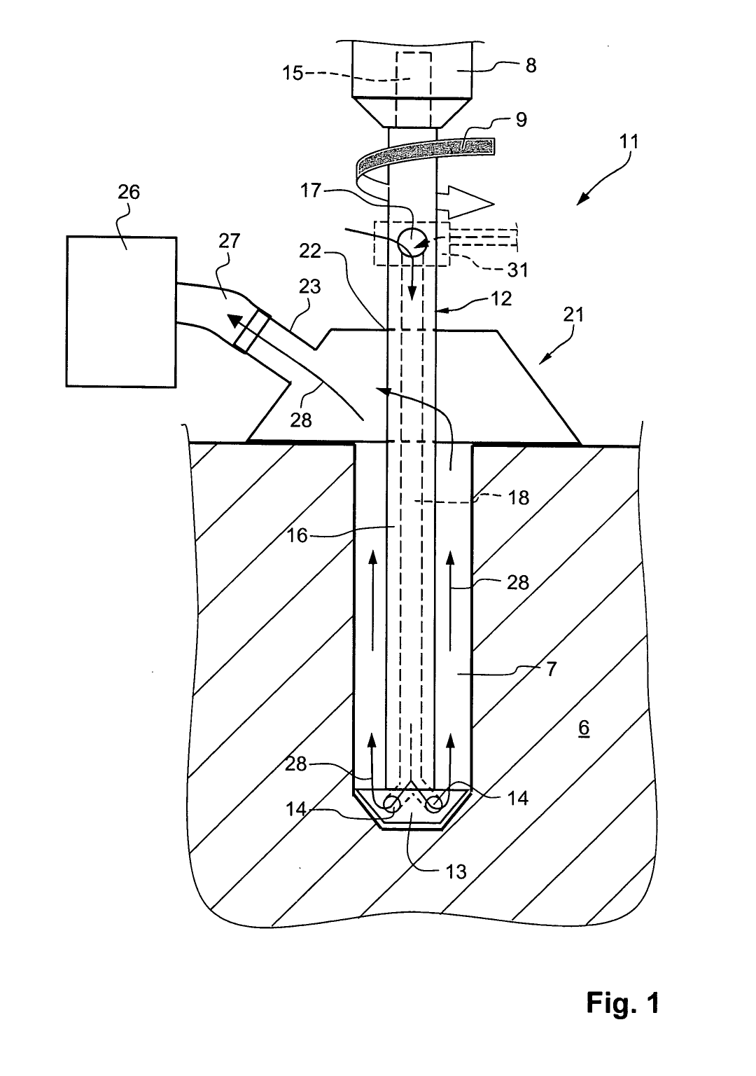

A device 11, which is shown in FIG. 1, is used for carrying out a process according to the present invention for forming a cleaned borehole 7 in a constructional component 6, e.g., in a concrete ceiling for chemically anchoring a fastening element 46 in the constructional component 6. The device 11 includes a hollow drill 12, a suction hood 21, and a vacuum source 26, e.g., a vacuum cleaner.

The hollow drill 12 has a shaft 16 having, at its first, front end, a drilling head 13 with outlet openings 14 and at its other rear end, a shank 15 for insertion of the hollow drill 12 in a chuck 8 in a percussion-rotary drilling tool, not shown in the drawing.

At a distance from the shank 8, there is provided an inlet opening 17 that opens radially outwardly and is connected with the outlet opening 14 in the drilling head 13 by a circumferentially closed elongate channel 18 provided in the shaft 16.

The suction hood 21 is bell-shaped and is provided with a through-opening 22 for the hollow drill 12 and a connection union 23 for connection with a suction conduit 27 that connects the suction hood 21 with the vacuum source 26. The through-opening 22 can be provided with sealing means, e.g., with projecting radially inwardly, brush elements or flexible sealing elements for partially sealing the through-opening 22.

For forming the cleaned borehole 7 in the constructional component 6, the hollow drill 12 is rotated by the drilling tool, as shown by arrow 9, and is percussively driven in the axial direction, with the hollow drill penetrating into the borehole 7 in the constructional component 6 up to a desired depth of the borehole 7. Simultaneously, the vacuum source 26 is actuated. During the drilling of the borehole 7 with the hollow drill 12, air and, thus, drillings and drilling dust, which are produced during drilling, are aspirated by the vacuum source 26 through the gap between the outer side of the hollow drill 12 and the wall of the borehole 7. Simultaneously, air continuously flows in the borehole 7 through the inlet opening 17 of the hollow drill 12. This insures an advantageous air flow for removing drillings and drilling dust (see flow arrow 28).

Optionally, e.g., a feed adapter 31 can be provided in the region of the inlet opening 17. During the drilling of the borehole 7 additional air can be actively blown in through the hollow drill 12, if needed, through the adapter 31.

After a desired depth of the borehole 7 has been reached, the device 11 is removed. The formed borehole 7 is already adequately cleaned. Thus, no further operational step for cleaning the borehole 7 is needed before filling the borehole 7 with a hardenable mass 41. A fastening element 46, e.g., a threaded rod is pushed into borehole 7 filled with the hardenable mass 41. After hardening of the hardenable mass 41 in the borehole 7, the anchored fastening element 46 has noticeably higher pull-out value then a fastening element chemically anchored in a conventionally formed borehole that was not subsequently optimally cleaned.

Also, mechanically anchored fastening elements, which were anchored in a borehole produced by the inventive process, achieved higher pull-out value than they are anchored in a conventionally formed borehole.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A method of anchoring a fastening element, comprising the steps of drilling a borehole (7) in a constructional component (6) with a percussively-rotationally driven hollow drill (12); aspirating produced drillings and drilling dust with a vacuum source (26) between an outer side of the hollow drill (12) and a borehole wall during drilling of the borehole (7); immediately after formation of the suction-cleaned borehole (7), filling the borehole (7) with a self-hardenable mortar (41); and inserting the fastening element (46) into the self-hardenable mortar (41).

2. A method according to claim 1, wherein the self-hardenable mortar is brought into the borehole (7) as two components.

3. A method according to claim 1, wherein the self-hardenable mortar is based on at least one of epoxy resin and polymethacrylat.

4. A method according claim 1, wherein the self-hardenable mortar is brought into the borehole, without any further cleaning of the borehole.

5. A method according to claim 1, wherein the anchored fastening element has been designed for being subjected to pull-out loads of at least 1000 Newton.

6. A method of forming a cleaned borehole in a constructional component (6) for anchoring a fastening element (46) in the constructional component (6), with a self-hardenable mortar, comprising the steps of drilling a borehole (7) in a constructional component (6) with a percussively-rotationally driven hollow drill (12); and aspirating produced drillings and drilling dust with a vacuum source (26) between an outer side of the hollow drill (12) and a borehole wall during drilling of the borehole.

7. A method according to claim 1, comprising the step providing a suction hood (21) for covering the borehole (7) and having a through-opening for the hollow borehole (12) and a connection union (22) for the vacuum source (26).

8. A method according to claim 1, comprising the step of blowing additional air in the borehole (7) through the hollow drill (12) during drilling of the borehole (7).
